(19) United States
(12) Patent Application Publication
(10) Pub. No.: US 2017/0068781 A1
(43) Pub. Date: Mar. 9, 2017

(54) COMPUTER-ASSISTED MEDICAL INFORMATION ANALYSIS

(71) Applicant: 3M INNOVATIVE PROPERTIES COMPANY, St. Paul, MN (US)

(72) Inventors: Jeremy M. Zasowski, Cambridge, MA (US); Rebecca H. Caux, Colorado Springs, CO (US); Jeffrey S. Seese, Hanover, PA (US)

(73) Assignee: 3M INNOVATIVE PROPERTIES COMPANY, St. Paul, MN (US)

(21) Appl. No.: 15/120,140

(22) PCT Filed: Feb. 18, 2015
(86) PCT No.: PCT/US15/16239

§ 371 Date: Aug. 19, 2016

Related U.S. Application Data
(60) Provisional application No. 61/942,806, filed on Feb. 21, 2014.

(51) Int. Cl. G06F 19/00; G06F 17/30

(52) U.S. Cl. CPC G06F 19/322; G06F 17/30554; G06F 19/328

(57) ABSTRACT

This disclosure describes systems, devices, and techniques for determining discrepancies in medical information. In one example, a computer-implemented method includes receiving clinical documentation related to a patient encounter, receiving one or more selected codes associated with the patient encounter, and determining, by the computing device, one or more suggested codes associated with the patient encounter and based on clinical documentation. The method may also include determining one or more discrepancies between the one or more selected codes and the one or more suggested codes, responsive to determining the one or more discrepancies, generating, based on the one or more discrepancies, a query that indicates the one or more discrepancies and solicits user input resolving the one or more discrepancies, and outputting the query for display.

### TECHNICAL FIELD

The invention relates to systems and techniques for managing medical information.

### BACKGROUND

In the medical field, accurate processing of records relating to patient visits to hospitals and clinics ensures that the records contain reliable and up-to-date information for future reference. Accurate processing may also be useful for medical systems and professionals to receive prompt and precise reimbursements from insurers and other payors. Some medical systems may include electronic health record (EHR) technology that assists in ensuring records of patient visits and files are accurate in identifying information needed for reimbursement purposes. These EHR systems generally have multiple specific interfaces into which medical professionals may input information about the patients and their visits.

### SUMMARY

In general, this disclosure describes systems and techniques for determining discrepancies within medical information. For example, systems described herein may analyze different types of medical information (e.g., clinical documentation and medical codes) to determine discrepancies between the different types of medical information associated with a patient that may convey similar concepts. These discrepancies may be caused by inadvertent errors from physicians entering the medical information or incomplete portions of the medical record. In one example, clinical documentation generated by the physician may not support an evaluation and management (E/M) code or procedure code selected by the physician. The system may determine and present suggested codes that match the clinical documentation. Alternatively, or in addition, the system may generate a query in response to determining a discrepancy and output the query for display. The query may indicate the discrepancy and solicit user input (e.g., input from the physician) that will resolve the discrepancy. User input may include modifying or creating an addendum to the clinical documentation and/or adjusting one or more of the previously selected codes.

In one example, this disclosure describes a computer-implemented method for managing medical information, the method including receiving, by a computing device, clinical documentation related to a patient encounter, receiving, by the computing device, one or more selected codes associated with the patient encounter, determining, by the computing device, one or more suggested codes associated with the patient encounter and based on clinical documentation, determining, by the computing device, one or more discrepancies between the one or more selected codes and the one or more suggested codes, and responsive to determining the one or more discrepancies, generating, by the computing device and based on the one or more discrepancies, a query that indicates the one or more discrepancies and solicits user input resolving the one or more discrepancies, and outputting, for display, the query.

In another example, this disclosure describes a computerized system for managing medical information, the system including one or more computing devices configured to receive clinical documentation related to a patient encounter, receive one or more selected codes associated with the patient encounter, determine one or more suggested codes associated with the patient encounter and based on clinical documentation, determine one or more discrepancies between the one or more selected codes and the one or more suggested codes, responsive to determining the one or more discrepancies, generate, based on the one or more discrepancies, a query that indicates the one or more discrepancies and solicits user input resolving the one or more discrepancies, and output, for display, the query.

In an additional example, this disclosure describes a computer-readable storage medium including instructions that, when executed, cause one or more processors to receive clinical documentation related to a patient encounter, receive one or more selected codes associated with the patient encounter, determine one or more suggested codes associated with the patient encounter and based on clinical documentation, determine one or more discrepancies between the one or more selected codes and the one or more suggested codes, responsive to determining the one or more discrepancies, generate, based on the one or more discrepancies, a query that indicates the one or more discrepancies and solicits user input resolving the one or more discrepancies, and output, for display, the query.

The details of one or more examples of the described systems, devices, and techniques are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example distributed system configured to determine one or more discrepancies within medical information of a patient consistent with this disclosure.

FIG. 2 is a block diagram illustrating the server and repository of the example of FIG. 1.

FIG. 3 is a block diagram illustrating a stand-alone computing device configured to determine one or more discrepancies within medical information.

FIG. 4 is a flow diagram illustrating an example workflow for determining and resolving discrepancies within medical information.

FIG. 5 is a flow diagram illustrating an example technique for determining one or more discrepancies within medical information.

FIG. 6 is a flow diagram illustrating an example technique for generating and presenting a query that identifies a discrepancy within medical information.

FIG. 7 is an illustration of an example user interface that includes a query that identifies a discrepancy within medical information.

FIG. 8 is an illustration of an example user interface that includes a query that identifies a discrepancy between two types of medical information.

FIG. 9 is an illustration of an example user interface that includes a query with a list of selectable items to resolve the discrepancy.

### DETAILED DESCRIPTION

This disclosure describes systems and techniques for determining discrepancies within medical information. When a physician visits with a patient (e.g., a patient encounter), the physician may perform an evaluation of the patient, review medical history of the patient, or evaluate the current medical condition of the patient. The physician may also, or alternatively, perform a medical procedure on the patient during the patient encounter that may be related to the medical condition. The physician may document or record any aspects of the patient encounter as medical information related to the patient. Typically, the physician may create a clinical documentation that describes or narrates aspects of the patient encounter such as evaluations and procedures that were performed. In addition, the physician may select one or more codes representing evaluations, diagnoses, procedures, or treatments that occurred during or as a result of the patient encounter. However, inadvertent discrepancies between clinical documentation and selected codes may create an inconsistent electronic health record of the patient and cause overbilling or underbilling issues for the physician.

As described herein, various techniques and systems may analyze different types of medical information (e.g., clinical documentation and medical codes) to automatically identify discrepancies between the types of medical information and facilitate the resolution of such discrepancies. Clinical documentation may include information provided by a physician, such as free form text or natural language (e.g., unstructured data) and selected check-boxes, drop-down menus, fill-in-the-blank items, or any other information (e.g., structured data) provided by the physician to describe aspects of the patient. The clinician documentation may be stored as structured data in an EHR, but the clinical documentation may be converted or outputted as one or more clinical document including structured and unstructured data for processing by a natural language processing engine. Medical codes may include billing codes, procedural codes, diagnostic codes that may represent actions or services of the physician. In some examples, medical codes may refer to medications or other prescribed treatments. The medical codes selected by the physician may indicate similar subject matter as the clinical documentation, but medical codes may be used for different purposes than the clinical documentation. In some examples, a single document including clinical documentation and medical codes may be analyzed for any discrepancies therein.

A system may receive medical information generated by the physician during a patient encounter. The medical information may include different types of information such as one or more clinical documentation, one or more evaluation and management codes, one or more procedure codes, one or more diagnostic codes, one or more therapy codes, or any other types of information. The system may process natural language from clinical documentation to identify one or more medical concepts representing the patient encounter and generate one or more suggested codes from the medical concepts. In some examples, the system may output, for display to the physician, the suggested codes to enable the physician to review the accuracy of the physician selected codes.

In addition, or alternatively, the system may compare the suggested codes from the analysis of natural language in the clinical documentation to the medical codes that were selected by the physician. If the suggested codes do not match the physician selected codes, the system may determine one or more discrepancies based on this mismatch of different types of the medical information. In response to determining the discrepancies, the system may generate a query that identifies the one or more discrepancies and solicits the physician to resolve the one or more discrepancies. The system may output the query for display to the physician, e.g., display the query within a user interface related to the acquisition and/or presentation of patient records.

The query may include one or more selectable items of a list that, when selected, command the system to resolve the discrepancy according to the selected item. For example, the system may present one or more suggested codes as selectable items, and responsive to a suggested code being selected, the system may adjust the selected code of the discrepancy with the suggested code selected from the list of the query. In another example, responsive to user input selecting to modify or amend clinical documentation associated with the discrepancy, the system may present clinical documentation for editing or an addendum into which the physician may add description supporting the selected codes. In response to receiving the edited document or addendum or the suggested code selected from the list, the system may recognize that the discrepancy has been resolved and submit clinical documentation to another system, such as a billing system or electronic health record system.

As described herein, medical information may include any data related to a medical patient. For example, medical information may include one or more clinical documents, evaluation and management (E/M) level codes, procedure codes (e.g., common procedure terminology (CPT) codes), diagnosis codes (e.g., ICD-9 or ICD-10 codes), or prescribed treatments such as medications. In some examples, the clinical documentation and one or more medical codes may be included in the same documentation, but discrepancies within the documentation may still be determined and addressed as described herein. Although medical information is described as being created or generated by a physician, the information may be input by an assistant, nurse, or clinician at the direction of a physician. In addition, the processes and systems herein may analyze medical information from one patient encounter or more than one patient encounter. In this manner, a system may analyze medical information as it is entered into the system to determine any discrepancies (e.g., before the patient encounter is complete) or retroactively after the medical information is stored and/or submitted for billing. The examples described herein will refer to clinical documentation, but the clinical documentation may contain one or more document each including one or more separated regions, pages, or sections each including medical data related to a patient. Although the patients described herein are generally human patients, the systems and techniques described herein may also apply to non-human patients.

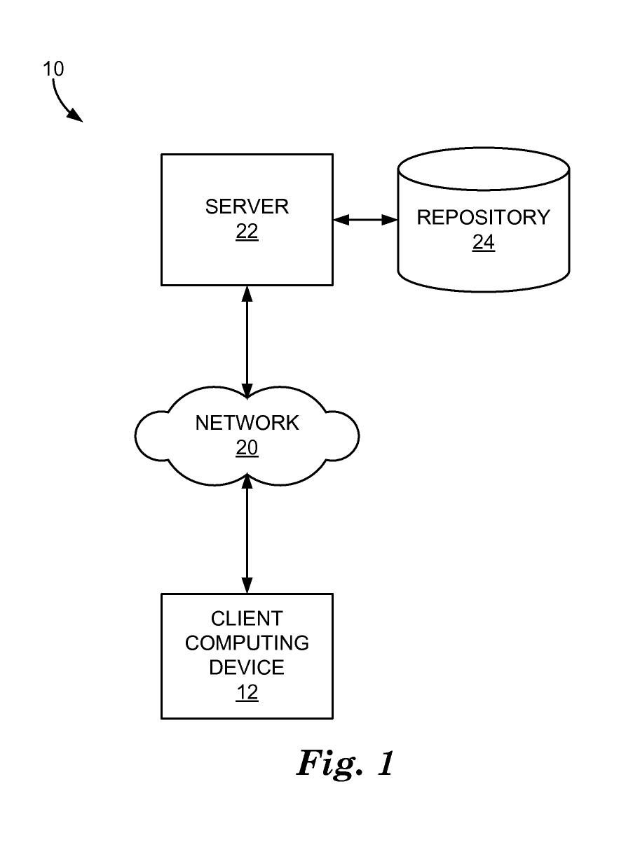

FIG. 1 is a block diagram illustrating an example distributed system configured to determine one or more discrepancies within medical information of a patient consistent with this disclosure. As described herein, system 10 may include one or more client computing devices 12, a network 20, server computing device 22, and repository 24. Client computing device 12 may be configured to communicate with server 22 via network 20. Server 22 may receive various requests from client computing device 12 and retrieve various information from repository 24 to address requests from client computing device 12. In some examples, server 22 may generate information, such as suggested codes and queries for client computing device 12.

Server 22 may include one or more computing devices connected to client computing device 12 via network 20. Server 22 may perform the techniques described herein, and a user may interact with system 10 via client computing device 12. Network 20 may include a proprietary or non-proprietary network for packet-based communication. In one example, network 20 may include the Internet, in which case each of client computing device 12 and server 22 may include communication interfaces for communicating data according to transmission control protocol/internet protocol (TCP/IP), user datagram protocol (UDP), or the like. More generally, however, network 20 may include any type of communication network, and may support wired communication, wireless communication, fiber optic communication, satellite communication, or any type of techniques for transferring data between two or more computing devices (e.g., server 22 and client computing device 12).

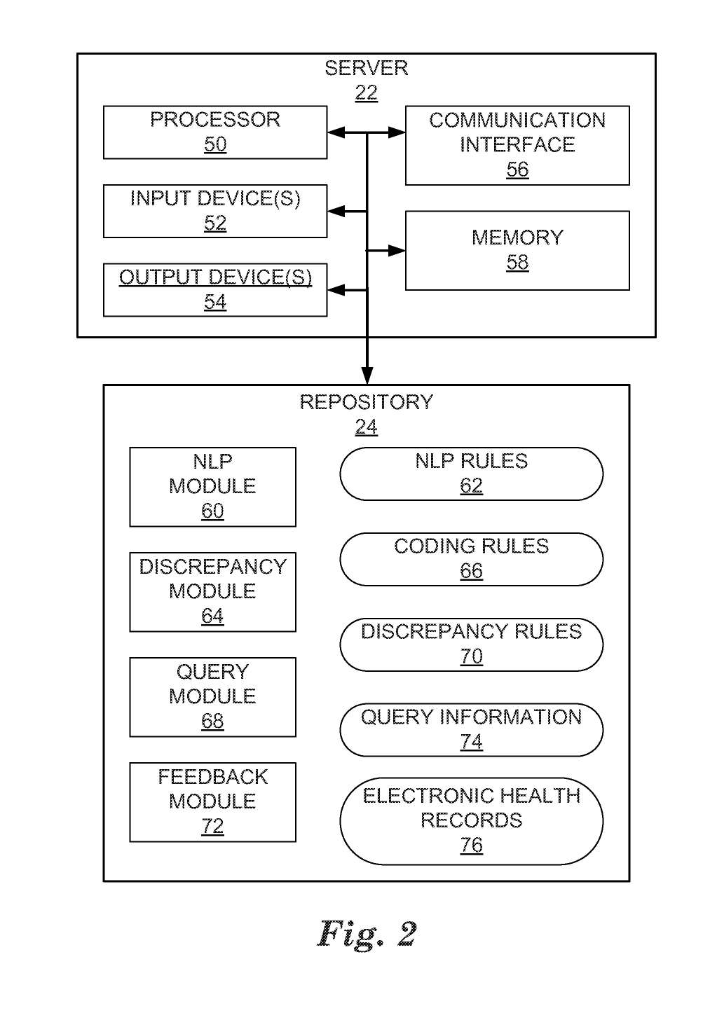

Server 22 may include one or more processors, storage devices, input and output devices, and communication interfaces as described in FIG. 2. Server 22 may be configured to provide a service to one or more clients, such as determining discrepancies within medical information (e.g., between different types of medical information), generating and outputting queries that identify discrepancies to the physician, and resolve the discrepancies based on additional user input. Server 22 may operate on within a local network or be hosted in a Cloud computing environment. Client computing device 12 may be a computing device associated with an entity (e.g., a hospital, clinic, university, or other healthcare organization) that provides information to a physician during a patient encounter and/or receives input documenting aspects of the patient encounter. Examples of client computing device 12 include personal computing devices, computers, servers, mobile devices, smart phones, tablet computing devices, etc. Client computing device 12 may be configured to upload generated medical information to server 22 for analysis and determination of any discrepancies by server 22. Alternatively, client computing device 12 may be configured to retrieve queries and/or other information generated by server 22 and stored in repository 24. Server 22 may also be configured to communicate with multiple client computing devices 12 associated with the same entity and/or different entities.

When a physician sees a patient in either an outpatient clinic or during an office visit (e.g., a patient encounter), the physician typically performs an evaluation of the patient, the patient's medical history and/or the patient's current medical condition. The physician may also perform a medical procedure on the patient during the patient encounter or prescribe treatment related to the patient's medical condition.

In order to be reimbursed for these medical services, a physician may submit a claim for the services performed during the patient encounter. The evaluation and medical decisions made by the physician during the patient encounter may be submitted for billing as an E/M code. An E/M level code may include details on certain components that are combined to provide the E/M level code. Example components of the code may include a history, exam (e.g., Exam 95 and/or Exam 97), and medical decision making Any procedures that are performed during the patient encounter may be submitted for billing as CPT codes. The physician may also submit appropriate diagnosis codes (e.g., ICD-9 or ICD-10 codes) related to the patient's condition which may accompany the E/M code and CPT codes. One, some, or even all of these generated codes for the patient encounter may be submitted to the clinic or office billing system of the physician for submission to the appropriate insurance payer.

The E/M code has several levels, depending on how in-depth, time-consuming and involved the physician evaluation of the patient was for that particular patient encounter. The criteria involved in selecting the appropriate level for each visit are complex and broken down into multiple components and sub-components related to what the physician did during the patient encounter. Physicians and their clinic or office staff routinely face issues of physicians either undercoding (i.e. selecting a lower E/M level than is appropriate for the level of services rendered) or overcoding (i.e. selecting an E/M level above what is appropriate for the level of services rendered or documented). Underbilling can result in lower compensation for the physician and clinic, and overbilling may result in additional administrative burden, payer enforced penalties, or other sanctions.

Physicians using an Electronic Health Record (EHR) in their clinic or office typically generate an E/M code, CPT codes, and/or diagnosis codes from a series of pick-lists, check-boxes and drop-down menu items, which the EHR uses to automatically calculate the E/M level. Physicians typically also add a clinical documentation note (e.g., clinical documentation) for the patient encounter to further detail the services that were provided by the physician and/or clinic. Without comparing the selected codes to clinical documentation, inadvertent or unknown errors may occur in the EHR and/or billing information submitted to be paid.

System 10 may operate to catch discrepancies within the medical information and prompt physicians or other users to resolve the discrepancies that may result, or have resulted, in inaccurate EHR and/or billing data. For example, server 22 may use a natural language processing (NLP) module to analyze clinical documentation created by the physician and, in some examples, documentation produced from any selected codes. Server 22 may then generate, from this documentation and for a patient encounter, suggested codes such as a suggested E/M level code, a suggested CPT code, and/or a suggested diagnosis code. Server 22 may use the suggested codes to provide different categories of feedback. In one example, server 22 may provide guidance to the physician by outputting, for display, the suggested codes to the physician. The physician may then use the suggested codes to either select appropriate codes or confirm the accuracy of already selected codes.

In addition, or alternatively, server 22 may determine if there are any discrepancies between clinical documentation and any physician selected codes. If server 22 determines that there are any discrepancies, server 22 may generate a respective query that identifies the discrepancy and solicits user input to resolve the discrepancy. The physician may modify clinical documentation, adjust one or more codes, provide one or more billing edits (e.g., missing modifiers in the codes), or any other appropriate adjustment to the medical information to address and resolve the discrepancies determined by server 22.

In one example, system 10 may include one or more computing devices (e.g., server 22) configured to receive clinical documentation related to a patient encounter with a physician and receive one or more selected codes associated with the patient encounter. Server 22 may receive clinical documentation and/or selected codes from client computing device 12 from which the associated user input was received. Server 22 may then determine one or more suggested codes from clinical documentation and associated with the patient encounter, such as codes that would logically be derived from the information contained within clinical documentation. Server 22 may determine one or more discrepancies between the one or more selected codes and the one or more suggested codes, and, responsive to determining the one or more discrepancies, generate, based on the one or more discrepancies, a query that indicates the one or more discrepancies and solicits user input resolving the one or more discrepancies. Server 22 may output the query for display, such as by a display device associated with client computing device 12 that interfaces with the physician or another user.

Clinical documentation, or one or more clinical documents, related to the patient encounter may include a natural language representation of the patient encounter created by the physician. For example, the physician may dictate or narrate various observations, diagnoses, procedures performed, or any other notes regarding the patient encounter. Dictated or narrated information may include voice data recognized and converted to text for processing via NLP techniques described herein. The clinical documentation may also include data from one or more check-boxes, drop-down menus, fill in the blank, or any other pre-determined information selected by the physician. The one or more selected codes may include at least one of an E/M level code, a diagnosis code (e.g., an ICD-9 or ICD-10 code), a procedural code (e.g., a CPT code), or even a prescribed medication. In other words, the selected codes may be selected items such as medical codes or medications. The selected codes may be separate from the clinical documentation and used for purposes such as billing physician time. In other examples, a single document or database (e.g., the EHR) may include the clinical documentation and the selected codes. In any case, the selected codes and the clinical documentation may represent similar aspects of patient evaluation and treatment and evaluated for potential discrepancies.

The selected codes may be medical codes that the physician selects from a drop-down menu, list, or other such grouping of possible codes. The physician may also input the code manually. However, the selected codes may also include medical codes initially suggested for selection by the physician based on medical information. The system may accept input validating, confirming, deleting or modifying the suggested medical codes and establish the codes as selected only after receiving physician input confirming the codes. In this manner, selection of codes by the physician may be entirely manual or computer-assisted to reduce physician time needed to select codes.

In some examples, server 22 may include a natural language processing (NLP) module configured to analyze clinical documentation for one or more medical concepts. The NLP module or another module may be configured to generate the one or more suggested codes from the one or more medical concepts. In addition, server 22 may include a discrepancy module that compares the suggested codes to selected codes from the physician to determine if there are any discrepancies (e.g., mismatches or inconsistencies) between the suggested and selected codes.

Responsive to determining the one or more discrepancies, server 22 may withhold clinical documentation and the one or more selected codes from submission to a billing system. In response to presentation of the query, server 22 may receive user input updating at least one of clinical documentation and the one or more selected codes to resolve the discrepancy, and, responsive to receiving the user input, submit at least one of the updated clinical documentation or the updated one or more selected codes to the billing system. In this manner, sever 22 may proactively attempt to resolve any discrepancies before any incomplete medical information is submitted. Alternatively, server 22 may perform post-submission analysis to check any information that has been previously submitted.

Server 22 may generate the query as a form of feedback to the physician when any discrepancy is identified. The query may indicate clinical documentation and the one or more selected codes for which the discrepancy was determined to quickly direct the attention of the physician to the problem. In some examples, the query may include a list of selectable items, wherein the query may receive user input selecting one of the selectable items from the list to resolve the discrepancy. The query may solicit user input to resolve the discrepancy by prompting the physician to manually modify clinical documentation, adjust a previously selected code to conform to the suggested code, or even confirm that there is no discrepancy.

In other examples, the query may provide actionable items that, when selected, cause server 22 to automatically correct the discrepancy. For example, server 22 may be configured to receive an indication of the user input selecting one of the selectable items from the list and modify, based on the indication of the user input, at least one of clinical documentation and the one or more selected codes to resolve the discrepancy. User input may be in the form of modifying clinical documentation, generating an addendum to clinical documentation, or adjusting, adding, removing, or replacing a medical code. As described herein, billing information for the patient encounter may be generated from the one or more selected codes or any updated code after prompting by a query.

If server 22 does not determine any discrepancies in the medical information, server 22 may submit the medical information (e.g., clinical documentation, selected codes, etc.) to the billing system. In some examples, a medical coding professional may review the selected codes for completeness and/or compliance with the billing system. If discrepancies were detected, server 22 may submit the medical information only after the discrepancies were resolved.

The processes described with respect to FIG. 1 and herein may be performed by one or more servers 22. In other examples, client computing device 12 may perform one or more of the steps of the discrepancy determination process and/or query generation. In this manner, system 10 may be referred to as a distributed system in some examples. Server 22 may utilize additional processing resources by transmitting some or all of the medical information to additional computing devices.

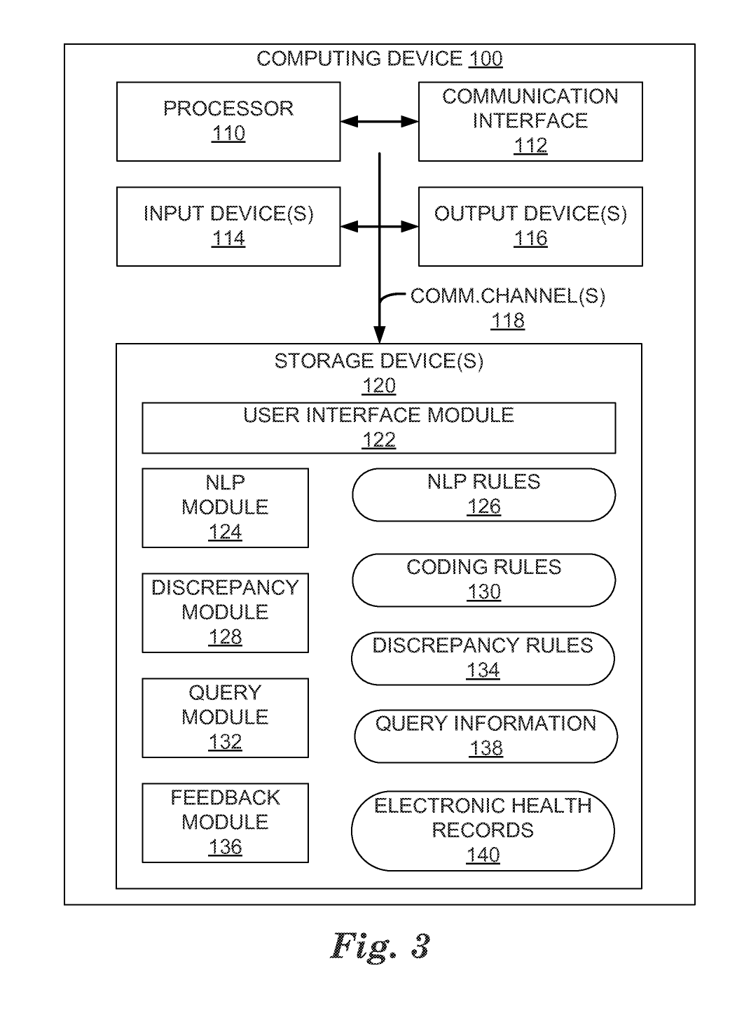

Client computing device 12 may be used by a user (e.g., a medical professional such as clinician, a healthcare facility administrator, or a medical coding expert) to upload or select clinical documents or medical codes as described herein. Client computing device 12 may include one or more processors, memories, input and output devices, communication interfaces for interfacing with network 20, and any other components that may facilitate the processes described herein. In some examples, client computing device 12 may be similar to computing device 100 of FIG. 3. In this manner, client computing device 12 may be configured to perform one or more steps of the discrepancy determination and/or query generation processes with the aid of server 22 in some examples.

FIG. 2 is a block diagram illustrating the server and repository of the example of FIG. 1. As shown in FIG. 2, server 22 includes processor 50, one or more input devices 52, one or more output devices 54, communication interface 56, and memory 58. Server 22 may be a computing device configured to perform various tasks and interface with other devices, such as repository 24 and client computing devices (e.g., client computing device 12 of FIG. 1). Although repository 24 is shown external to server 22, server 22 may include repository 24 within a server housing in other examples. Server 22 may also include other components and modules related to the processes described herein and/or other processes. The illustrated components are shown as one example, but other examples may be consistent with various aspects described herein.

Processor 50 may include one or more general-purpose microprocessors, specially designed processors, application specific integrated circuits (ASIC), field programmable gate arrays (FPGA), a collection of discrete logic, and/or any type of processing device capable of executing the techniques described herein. In some examples, processor 50 or any other processors herein may be described as a computing device. In one example, memory 58 may be configured to store program instructions (e.g., software instructions) that are executed by processor 50 to carry out the techniques described herein. Processor 50 may also be configured to execute instructions stored by repository 24. Both memory 58 and repository 24 may be one or more storage devices. In other examples, the techniques described herein may be executed by specifically programmed circuitry of processor 50. Processor 50 may thus be configured to execute the techniques described herein. Processor 50, or any other processes herein, may include one or more processors.

Memory 58 may be configured to store information within server 22 during operation. Memory 58 may comprise a computer-readable storage medium. In some examples, memory 58 is a temporary memory, meaning that a primary purpose of memory 58 is not long-term storage. Memory 58, in some examples, may comprise as a volatile memory, meaning that memory 58 does not maintain stored contents when the computer is turned off. Examples of volatile memories include random access memories (RAM), dynamic random access memories (DRAM), static random access memories (SRAM), and other forms of volatile memories known in the art. In some examples, memory 58 is used to store program instructions for execution by processor 50. Memory 58, in one example, is used by software or applications running on server 22 (e.g., one or more of modules 60, 64, 68, and 72) to temporarily store information during program execution.

Input devices 52 may include one or more devices configured to accept user input and transform the user input into one or more electronic signals indicative of the received input. For example, input devices 52 may include one or more presence-sensitive devices (e.g., as part of a presence-sensitive screen), keypads, keyboards, pointing devices, joysticks, buttons, keys, motion detection sensors, cameras, microphones, or any other such devices. Input devices 52 may allow the user to provide input via a user interface.

Output devices 54 may include one or more devices configured to output information to a user or other device. For example, output device 54 may include a display screen for presenting visual information to a user that may or may not be a part of a presence-sensitive display. In other examples, output device 54 may include one or more different types of devices for presenting information to a user. Output devices 54 may include any number of visual (e.g., display devices, lights, etc.), audible (e.g., one or more speakers), and/or tactile feedback devices. In some examples, output devices 54 may represent both a display screen (e.g., a liquid crystal display or light emitting diode display) and a printer (e.g., a printing device or module for outputting instructions to a printing device). Processor 50 may present a user interface via one or more of input devices 52 and output devices 54, whereas a user may control the abstraction and/or coding of clinical documentation via the user interface. In some examples, the user interface generated and provided by server 22 may be displayed by a client computing device (e.g., client computing device 12).

Server 22 may utilize communication interface 56 to communicate with external devices via one or more networks, such as network 20 in FIG. 1, or other storage devices such as additional repositories over a network or direct connection. Communication interface 56 may be a network interface card, such as an Ethernet card, an optical transceiver, a radio frequency transceiver, or any other type of device that can send and receive information. Other examples of such communication interfaces may include Bluetooth, 3G, 4G, and WiFi radios in mobile computing devices as well as USB. In some examples, server 22 utilizes communication interface 56 to wirelessly communicate with external devices (e.g., client computing device 12) such as a mobile computing device, mobile phone, workstation, server, or other networked computing device. As described herein, communication interface 56 may be configured to receive clinical documentation, codes, and/or transmit suggested codes and/or queries over network 20 as instructed by processor 50.

Repository 24 may include one or more memories, repositories, databases, hard disks or other permanent storage, or any other data storage devices. Repository 24 may be included in, or described as, cloud storage. In other words, information stored on repository 24 and/or instructions that embody the techniques described herein may be stored in one or more locations in the cloud (e.g., one or more repositories 24). Server 22 may access the cloud and retrieve or transmit data as requested by an authorized user, such as client computing device 12. In some examples, repository 24 may include Relational Database Management System (RDBMS) software. In one example, repository 24 may be a relational database and accessed using a Structured Query Language (SQL) interface that is well known in the art. Repository 24 may alternatively be stored on a separate networked computing device and accessed by server 22 through a network interface or system bus, as shown in the example of FIG. 2. Repository 24 may in other examples be an Object Database Management System (ODBMS), Online Analytical Processing (OLAP) database or other suitable data management system.

Repository 24 may store instructions and/or modules that may be used to perform the techniques described herein related to generating suggested codes, determining discrepancies within medical information and/or generating queries. As shown in the example of FIG. 2, repository 24 includes NLP module 60, discrepancy module 64, query module 68, and feedback module 72. Processor 50 may execute each of modules 60, 64, 68, and 72 as needed to perform various tasks. Repository 24 may also include additional data such as information related to the function of each module and server 22. For example, repository 24 may include NLP rules 62, coding rules 66, discrepancy rules 70, query information 74, and electronic health records 76. Repository 24 may also include additional data related to the processes described herein. In other examples, memory 58 or a different storage device of server 22 may store one or more of the modules or information stored in repository 24.

As described herein, server 22 may receive medical information entered (e.g., created) by a physician or at the direction of a physician to represent an encounter with a patient. For example, processor 50 may receive one or more clinical documentation describing the patient encounter or including notes regarding the patient. In addition, processor 50 may receive other medical information such as one or more medical codes that also describe aspects of the patient encounter. A medical code may be a predetermined code or category that describes medical concepts such as evaluation and management of the patient, diagnoses made by the physician, procedures performed by the physician, treatments ordered (e.g., a medication or outpatient activities), or any other aspect associated with the patient or the patient encounter. In the example of medications, processor 50 may determine that a physician selected medication is not supported by the clinical documentation, such as a missing diagnosis that would correlate with the selected medication or superfluous medications. In this manner, processor 50 may determine if there is a discrepancy between the clinical documentation and any medications prescribed by the physician. The medical codes may be selected to facilitate billing for the services of the physician and/or clinic. In this manner, the clinical documentation may be intended to describe the same subject matter or related subject matter as that represented by the one or more medical codes.

Processor 50 may be configured to analyze clinical documentation associated with a patient encounter. For example, processor 50 may be configured to process clinical documentation to identify one or more medical concepts from the narrative of clinical documentation and suggest one or more codes representative of the one or more concepts identified within clinical documentation. The natural language processing may be performed by NLP module 60 using rules and/or algorithms stored in NLP rules 62. NLP module 60 may also generate suggested codes from the medical concepts in clinical documentation according to the coding rules 66 stored in repository 24. In some examples, processor 50 may output, for display to the physician, these suggested codes as guidance in selecting the appropriate codes. The physician or other user may also use the suggested codes to confirm that previously selected codes are appropriate for the created clinical document for the patient encounter.

Processor 50 may also be configured to determine or identify any discrepancies between different types of medical information (e.g., clinical documentation and selected codes) for a patient encounter (or for any group of medical information). Using the algorithms and/or rules stored as discrepancy rules 70, processor 50 may determine, via execution of discrepancy module 64, any discrepancies within the medical information. For example, discrepancy module 64 may determine that one or more of the physician selected codes do not match the suggested codes generated by NLP module 60. In response to this determined discrepancy, discrepancy module 64 may generate a flag that identifies the mismatch or inconsistency between these types of information. The flag may be an internal flag which triggers processor 50 to generate a corresponding query. In some examples, a discrepancy may be determined for any non-identical match between selected codes and suggested codes. Alternatively, discrepancy module 64 may determine a discrepancy when one or more selected codes is not supported by the information contained within clinical documentation. Therefore, discrepancy module 64 may determine a discrepancy any time an exact match between selected codes and suggested codes does not exist or the correlation between suggested codes and selected codes is insufficient (e.g., below a predetermined threshold). In other examples, NLP module 60 may also perform the processes of discrepancy module 64.

Processor 50 may also request a physician or other user to resolve the discrepancy via a delivered query. For example, processor 50 may execute query module 68 to generate, using the query information 74, one or more queries that identify the discrepancies and solicit user input to resolve the discrepancy. The user input may provide modification of clinical documentation, an addendum to clinical documentation, adjustment of one or more codes, and/or any other change to the medical information originally generated by the physician. In some examples, query module 68 may generate a single query for a single discrepancy. In other examples, query module 68 may generate a single query for multiple different discrepancies. Query module 68 may output the query for display to a user.

The query may also be configured to receive the user input. In this manner, user input responding to the query may be received by feedback module 72 executed by processor 50. In response to receiving the user input via the query, or otherwise related to the query, feedback module 72 may modify one or more aspects of the medical information to resolve the discrepancy. In other examples, query module 68 may perform the processes of feedback module 72.

Processor 50 may thus output, via communication interface 56 and a network, queries to another computing device such as client computing device 12 of FIG. 1 for display to the physician. Processor 50 may also receive, via communication interface 56, indications of the user input provided to resolve the one or more discrepancies indicated by the queries. In response to receiving the user input, processor 50 may modify one or more aspects of the medical information and store the modified information as part of EHR 76. In some examples, processor 50 may submit the selected codes, or adjusted selected codes, to a billing system once the discrepancy has been resolved.

Electronic health records (EHR) 76 may include information related to clinical documentation that will be or have been analyzed by server 22. Alternatively, EHR 76 may include medical information already submitted by the physician and/or information resolved of any discrepancies. In some examples, server 22 may analyze information contained within EHR 76 for any discrepancies and resolve any discrepancies as described herein. In this manner, server 22 may retroactively analyze EHR 76 to determine discrepancies between medical information already stored as a part of the patient's EHR. EHR 76 may include medical information for a single patient or multiple patients. In some examples, medical information from different patients and/or healthcare entities may be physically separated into different memories of repository 24. Processor 50 may this receive medical information from EHR 76 in some examples.

Although server 22 is described as configured to perform the natural language processing of clinical documentation, determine any discrepancies in the medical information, and generate queries, each of these processes may be performed by different computing devices in other examples. For example, server 22 may not be configured to determine the discrepancies. Instead, server 22 may be configured to receive the determined discrepancies from another computing device and generate the corresponding queries. In this manner, different devices or systems may be configured to handle the tasks of analyzing clinical documentation, determine discrepancies in medical information and/or generate queries.

FIG. 3 is a block diagram illustrating a stand-alone computing device configured to determine one or more discrepancies within medical information. Computing device 100 may be substantially similar to server 22 and repository 24 of FIG. 2. However, computing device 100 may be a stand-alone computing device configured to perform the analysis of medical information and generation of queries. Computing device 100 may be configured as a workstation, desktop computing device, notebook computer, tablet computer, mobile computing device, or any other suitable computing device or collection of computing devices.

As shown in FIG. 3, computing device 100 may include processor 110, one or more input devices 114, one or more output devices 116, communication interface 112, and one or more storage devices 120, similar to the components of server computing device 22 of FIG. 2. Computing device 100 may also include communication channels 118 (e.g., a system bus) that allows data flow between two or more components of computing device 100, such as between processor 110 and storage devices 120. Computing device 100 also includes one or more storage devices 120, such as a memory, that stores information such as instructions for performing the processes described herein and data such as medical information for a patient and algorithms for determining discrepancies in the medical information and generating queries that solicit the resolution of the discrepancies.

Storage devices 120 may include data for one or more modules and information related to the discrepancy determination and query generation described herein. For example, storage devices 120 may include NLP module 124, discrepancy module 128, query module 132, and feedback module 136, similar to the modules described with respect to repository 24 of FIG. 2. Storage devices 120 may also include information such as NLP rules 126, coding rules 130, discrepancy rules 134, query information 138, and EHR 140, similar to the information described as stored in repository 24.

The information and modules of storage devices 120 of computing device 100 may be specific to a healthcare entity that employs computing device 100 to determine discrepancies in the medical information generated by healthcare professionals (e.g., physicians and/or nurses) associated with the healthcare entity. For example, coding rules 130 may contain a specific codeset that is used by the healthcare entity. In any case, computing device 100 may be configured to perform any of the processes and tasks described herein and with respect to server 22 and repository 24. Storage devices 120 may also include user interface module 122, which may provide a user interface for a user via input devices 114 and output devices 116.

In some examples, input devices 114 may include one or more scanners or other devices configured to convert paper documents into electronic clinical documents that can be analyzed by computing device 100. In other examples, communication interface 112 may receive electronic clinical documents from a repository or individual clinician device on which clinical documentation are initially generated. Communication interface 112 may thus send and receive information via a private or public network.

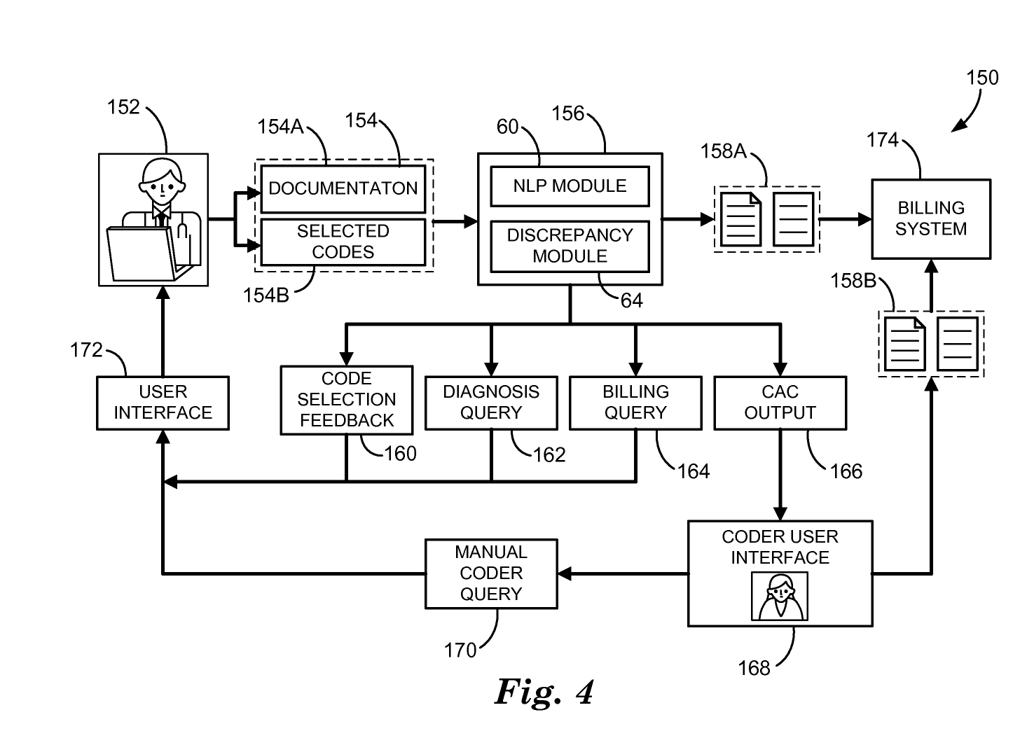

FIG. 4 is a flow diagram illustrating an example workflow for determining and resolving discrepancies within medical information. As shown in FIG. 4, system 150 may facilitate the identification of discrepancies in medical information 154 and the resolution of any discrepancies before submitting the medical information, or a portion of the medical information, to billing system 174 or a repository of the information for the patient. A physician may initially generate medical information regarding a patient encounter at block 152. This medical information 154 may include such types of information as clinical documentation 154A and physician selected codes 154B. Clinical documentation 154A may be a clinical document prepared or validated by the physician for the patient encounter, and selected codes 154B may be codes representing services provided by the physician or codes related to the patient evaluation, management, diagnosis, and/or treatment. In this manner, clinical documentation 154A and selected codes 154B may be intended to capture similar information from the patient encounter.

At block 156, NLP module 60 executed by server 22, for example, may perform natural language processing on clinical document 154A to identify medical concepts and/or generate suggested codes from clinical document 154A. Discrepancy module 64 executed by server 22 may compare the suggested codes from NLP module 60 to the physician selected codes. If discrepancy module 64 does not determine any discrepancies, server 22 may submit accepted medical information 158A to billing system 174. Accepted medical information 158A may include the originally generated clinical document 154A and the originally selected codes 154B. Alternatively, accepted medical information 158A may include a modified clinical document, addendum, adjusted codes, or changed information solicited by a query to resolve one or more discrepancies. In this manner, system 150 may operate to ensure accurate clinical documents and/or codes for billing purposes and minimize the possibility of underbilling and overbilling.

If discrepancy module 64 determines that there is a discrepancy within the medical information, one or more queries may be generated to identify the discrepancy, such as a diagnosis query 162 or a billing query 164. Each of these queries may be sent to user interface 172 that displays the query to the physician at block 152, and the physician may modify clinical documentation 154A or adjust one or more selected codes 154B. Even if discrepancy module 64 did not determine any discrepancies, NLP module 60 may output the suggested codes as code selection feedback 160 that is presented to the physician via user interface 172. Code selection feedback 160 may be presented to the physician to allow the physician to confirm or check the accuracy of selected codes 154B and/or clinical documentation 154A.

NLP module 60 may also provide a computer-aided coding (CAC) output 166 that is transmitted to a coding professional via coder user interface 168. CAC output 166 may include one or more suggested codes derived from medical information 154. The coding professional may send a manual coder query 170 to user interface 172 to solicit clarification from the physician. If the coding professional can determine appropriate billing codes via coder user interface 168, system 150 may transmit the accepted medical information 158B to billing system 174. Accepted medical information 158B may or may not include additional codes selected by the coding professional over the codes in accepted medical information 158A. Billing system 174 may be a billing system of the physician or clinic that generates invoices that are transmitted to the appropriate payer. Alternatively, billing system 174may be a billing system controlled by the payer into which accepted medical information 158A or 158B is submitted.

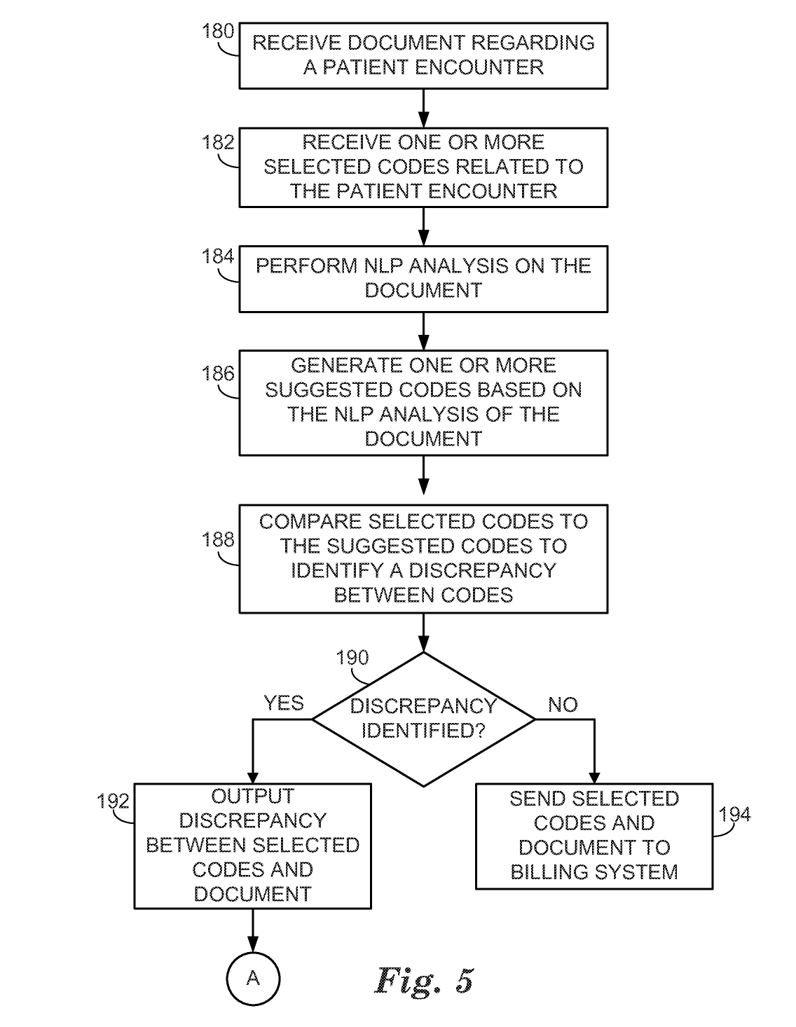

FIG. 5 is a flow diagram illustrating an example technique for determining one or more discrepancies within medical information related to a patient encounter. FIG. 5 will be described from the perspective of sever 22 and repository 24 of FIGS. 1 and 2, although computing device 100 of FIG. 3, any other computing devices or systems, or any combination thereof, may be used in other examples. As shown in FIG. 5, processor 50 receives clinical documentation regarding a patient encounter (180). Processor 50 also receives one or more selected codes related to the patient encounter (182). Both clinical documentation and the selected codes may be medical information related to the patient encounter.

Responsive to receiving clinical documentation, processor 50 may execute NLP module 60 to perform natural language processing analysis on clinical documentation (184). Processor 50 may also generate one or more suggested codes based on the NLP analysis of the document (186). The suggested codes may be codes that have support in clinical documentation, such as an E/M level code, a CPT code, an ICD-9 or ICD-10 code, or any other medical codes. Processor 50 may then execute discrepancy module 64 to compare the selected codes from the physician to the suggested codes in order to identify if there are any discrepancies between the selected codes and the suggested codes (188). Discrepancy module 64 may identify any non-identical matches between codes. Alternatively, discrepancy module 64 may generate a correlation between the selected codes and suggested codes and determine a discrepancy when the correlation is lower than a predetermined threshold.

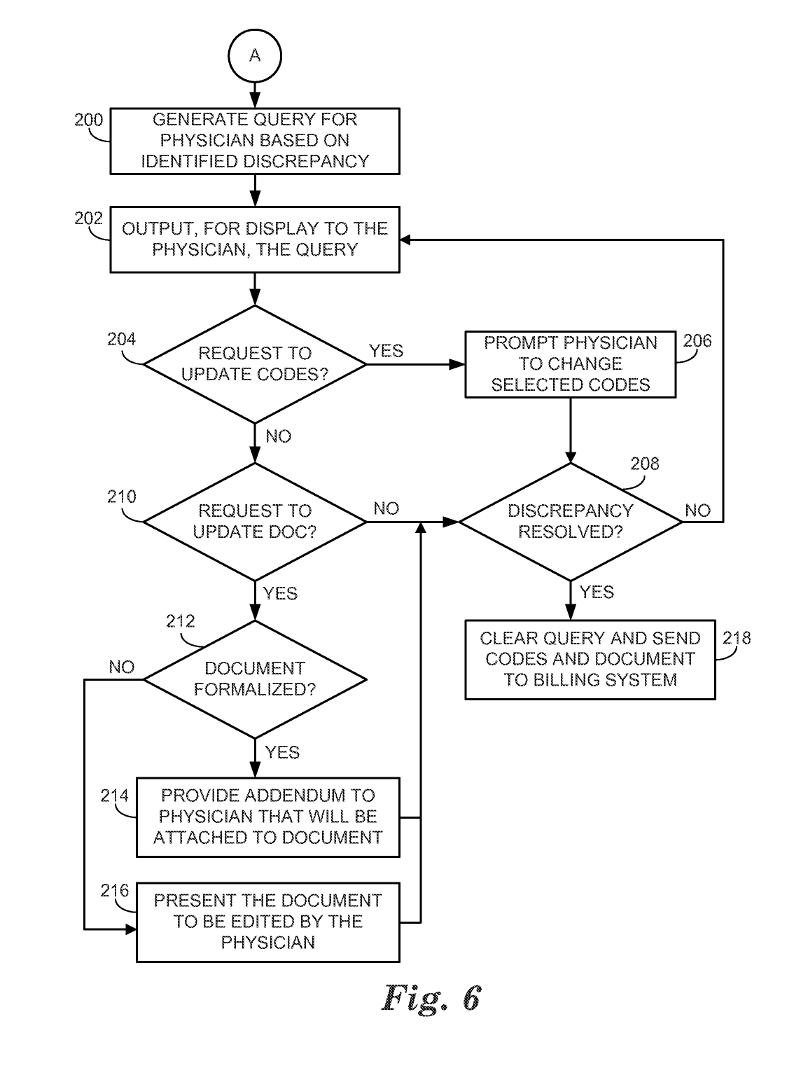

If discrepancy module 64 determines that there is a discrepancy (“YES” branch of block 190), processor 50 will output the discrepancy between the selected codes and clinical documentation (192). Processor may use the discrepancy to generate a query, as described in FIG. 6. If discrepancy module 64 does not identify any discrepancy (“NO” branch of block 194), processor 50 sends the selected codes and clinical documentation to a billing system (194). These sent codes and documents may be accepted medical information. In some examples, processor 50 may also transmit the accepted medical information for storage as part of the patient's electronic health record.

In other examples, the process of generating suggested codes (e.g., up to block 186) may be performed for a guidance mode in which processor 50 outputs the suggested codes for presentation to the user via a user interface. In this manner, the user may view the suggested codes as guidance for physician selection of the appropriate medical code. In one example, processor 50 may receive user input selecting, modifying, or confirming the suggested code as a selected code. Alternatively, the suggested codes may be presented and, processor 50 may select a code in a different field of the user interface. In any case, even if discrepancies are determined and a query is presented to the user, processor 50 may also present the suggested code or codes in addition (within or adjacent to) the one or more queries.

FIG. 6 is a flow diagram illustrating an example technique for generating and presenting a query that identifies a discrepancy within medical information. FIG. 6 will be described from the perspective of sever 22 and repository 24 of FIGS. 1 and 2, although computing device 100 of FIG. 3, any other computing devices or systems, or any combination thereof, may be used in other examples. As shown in FIG. 6, processor 50 may receive one or more discrepancies determined from the processes of FIG. 5. Processor 50 may execute query module 68 to generate a query for the physician based on the identified discrepancy (200). Processor 50 may then output, for display to the physician, the query (202). The query may indicate the discrepancy and solicit user input from the physician to resolve the discrepancy. For example, the user input may select a selectable item from a list provided by the query to resolve the discrepancy or manually modify an aspect of the medical information to resolve the discrepancy.

If processor 50 receives a request to update a selected code (“YES” branch of block 204), processor 50 may, via the query, prompt the physician to change the selected code or codes (206). The physician may manually return to the selected codes and adjust one of the codes. Alternatively, the query may present the suggested codes and/or other codes as selectable items, and processor 50 may adjust the selected code in response to the user input. If the discrepancy is still not resolved (“NO” branch of block 208), processor 50 may still output the query (202).

If processor 50 does not receive a request to update a selected code (“NO” branch of block 204), processor 50 may check to determine if a request has been received to update clinical documentation (210). If processor 50 has received a request to update clinical documentation (“YES” branch of block 212), processor 50 may check to determine if clinical documentation has been formalized (e.g., signed by the physician) (212). If clinical documentation has not been formalized (“NO” branch of block 212), processor 50 may present clinical documentation to the physician to be edited by the physician and resolve the discrepancy (216). If clinical documentation has been formalized (“YES” branch of block 212), processor 50 may provide an addendum to the physician that will be attached to the formalized clinical document (214). Processor 50 may receive textual input (additional description related to the patient encounter) from the physician and populate the addendum with the textual input. If the discrepancy is still not resolved (“NO” branch of block 208), processor 50 may still output the query (202). If processor 50 determines that the discrepancy has been resolved (“YES” branch of block 208), processor 50 will clear the query and send the updated codes and/or updated clinical document to the billing system (218). In some examples, the updated codes and/or updated clinical document may also be entered as part of the electronic health record of the patient.

In some examples, a selectable item in the query may be held for resolution a later time (e.g., “snooze” the query). In response to receiving such a selection from the physician, processor 50 may hold the query and present the query after a predetermined period of time, at the beginning of another physician session, or at any other time. The query may also have a selectable item in which the physician overrides a determined discrepancy. For example, the physician may determine that both clinical documentation and the selected codes are correct. In this manner, the physician may select an item from the query that confirms the medical information as correct. In response to receiving such a selection, processor 50 may store the response, dismiss the query, and proceed to submit the medical information for billing.

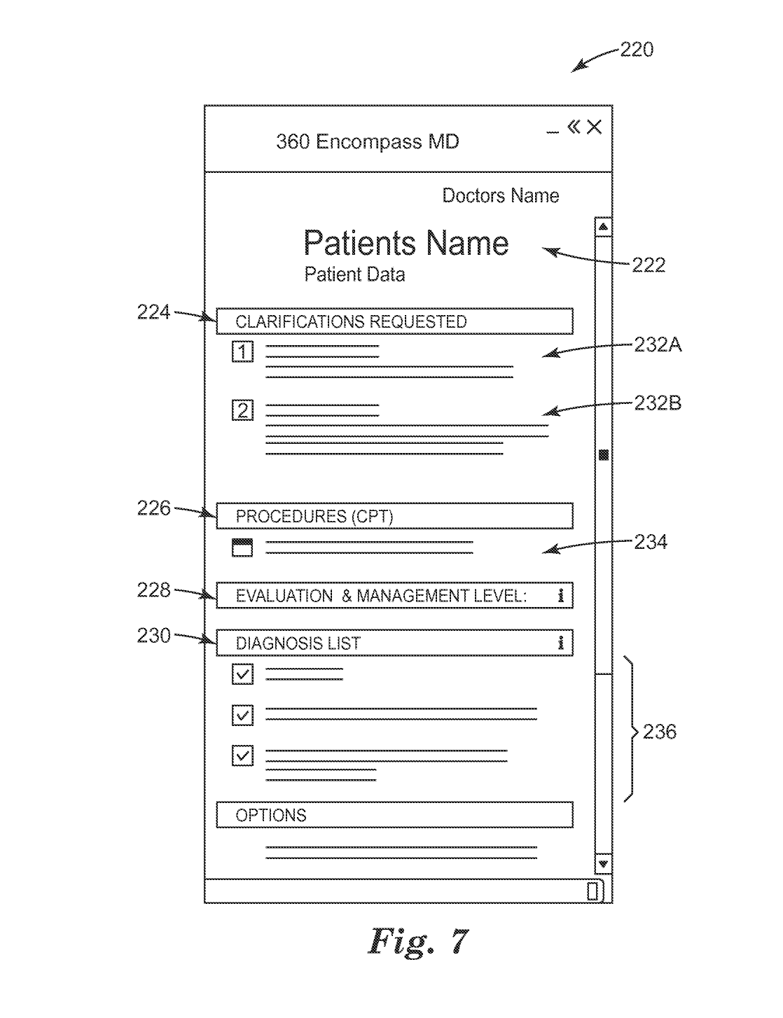

FIG. 7 is an illustration of an example user interface 220 that includes a query 232B that identifies a discrepancy within medical information. User interface 220 will be described as being generated by server 22 and displayed by a display device of client computing device 12, although user interface 220 may be generated by client computing device 12 or any other device with the query output by server 22, for example. As shown in FIG. 7, user interface 220 may include patient information 222, query field 224, procedure field 226, E/M field 228, and diagnosis list 230. User interface 220 may include more or less fields in other examples.

User interface 220 may be an independent interface generated and displayed to the physician. Alternatively, user interface 220 may be a pop-up window or portion of a larger user interface related to the management of patient information. In this manner, user interface 220 may be integrated into a larger system configured to receive and display information about a patient. For example, the physician may generate clinical documentation and/or select codes using the larger user interface that includes user interface 220. In response to determining a discrepancy, processor 50 may cause user interface 220 to appear for the physician such as a notification or alert. Alternatively, processor 50 may update a portion (e.g., query field 224) of user interface 220 with a query in response to determining the discrepancy. Patient information 222 may include information such as the patient's name, age, gender, location, date of birth, patient identification number, or any other related information.

Query field 224 may include unresolved queries. As shown in FIG. 7, queries 232A and 232B are currently pending queries. Query 232A is related to a request for further specificity of a patient condition. Query 232B is related to a determined discrepancy between the clinical documentation and an E/M code selected by the physician. Query 232B states “Please verify the E/M code” and provides a description of the discrepancy: “The assigned procedure codes may require the addition of a modifier on the E/M code.” The physician may select query 232B to view a list of selectable items to resolve the discrepancy, such as one or more modifiers that can adjust the E/M code, a request to “snooze” the query until a later time, a request to discard the query, or an indication that the physician will return to correct the E/M code. In some examples, query 232B may provide suggested codes or suggested actions to resolve the discrepancy. Upon resolution of the discrepancy, processor 50 may clear, or delete, query 232B from query field 224.

Procedure field 226 may provide one or more procedure codes selected by the physician for the patient encounter. Procedure code 234 is shown as an example and indicates that the procedure has a code of “11200” and a description of “Removal of skin tags.” E/M field 228 lists the selected E/M level code, which is shown as a level “4” to describe the level of service the physician has performed during the patient encounter. In some examples, selection of the header to E/M field 228 may expand the field to provide details resulting in the shown code. Diagnosis list 230 may provide one or more different diagnoses 236 related to the patient. Diagnosis list 230 may list diagnoses created during the patient encounter or all of the diagnoses currently applicable to the patient. User interface 220 may include additional fields or information in other examples consistent with this disclosure.

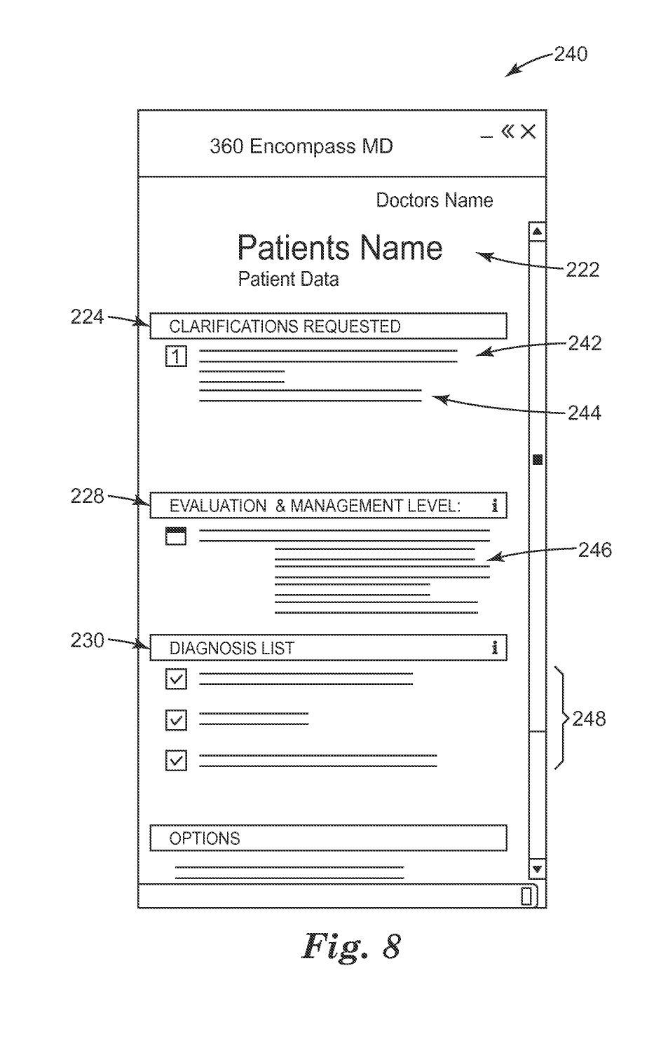

FIG. 8 is an illustration of an example user interface 240 that includes a query that identifies a discrepancy between two types of medical information. User interface 240 may be similar to user interface 220 of FIG. 7 and will be described as being generated by server 22 and displayed by a display device of client computing device 12. However, user interface 240 may be generated by client computing device 12 or any other device with the query output from server 22, for example. As shown in FIG. 8, user interface 240 may include patient information 222, query field 224, E/M field 228, and diagnosis list 230. User interface 240 may include more or less fields in other examples. For example, user interface 240 may include additional fields for other codes selected by the physician, such as a procedural code or one or more medications prescribed for patient therapy.

Similar to user interface 220, user interface 240 may be an independent interface generated and displayed to the physician. Alternatively, user interface 240 may be a pop-up window or portion of a larger user interface related to the management of patient information. In this manner, user interface 240 may be integrated into a larger system configured to receive and display information about a patient. For example, the physician may generate clinical documentation and/or select codes using the larger user interface that includes user interface 240. In response to determining a discrepancy, processor 50 may cause user interface 240 to appear for the physician such as a notification or alert. Alternatively, processor 50 may update a portion (e.g., query field 224) of user interface 240 with a query in response to determining the discrepancy. Patient information 222 may include information such as the patient's name, age, gender, location, date of birth, patient identification number, or any other related information.

Query field 224 of user interface 240 may include one or more unresolved queries. As shown in FIG. 8, query 242 is currently pending for the physician. Query 242 is related to a determined discrepancy between the clinical documentation (e.g., a “History and Exam” and an E/M level code of “4” selected by the physician. Therefore, query 242 has indicated the discrepancy and solicited user input to resolve the discrepancy. In particular Query 242 states that “History and Exam are insufficient to support level 4 MDM.” The physician would then know that either additional information should be added to clinical documentation to support the level 4 code that was selected or the physician needs to adjust the level of the code to a level supported by clinical documentation. In addition, query 242 may include additional details 244 that include more details about the discrepancy or indicate where the physician can view additional information. For example, details 244 request the physician “View E/M data for more information.”

In the example of FIG. 8, E/M field 228 lists the suggested E/M level code, which is shown as a level “2” to describe the level of service the physician has performed during the patient encounter, according to the information provided by the physician in clinical documentation. E/M data 246 includes additional details regarding the suggested E/M code. For example, E/M data 246 includes the code “99202” along with the different elements of the E/M code such as the “History,” “Exam 95,” “Exam 97,” and “Medical Decision Making ” Each of these elements includes a description that server 22 may have selected based on one or more medical concepts identified from clinical documentation. These elements, or at least a portion of the elements, of the E/M code in E/M field 228 may together define the E/M level. In other examples, user interface 240 may present the selected E/M level in addition or alternatively to the suggested E/M level. Presentation of the suggested E/M level code in E/M field 228 may also be used to provide guidance to the physician in selecting the appropriate E/M level code consistent with the natural language medical device

Diagnosis list 230 may provide one or more different diagnoses 248 related to the patient. Diagnosis list 230 may list diagnoses created during the patient encounter or all of the diagnoses currently applicable to the patient. In some examples, diagnosis list 230 may rank the diagnoses according to newest, oldest, most urgent, most recent treatment, or any other aspect of the diagnoses 248. User interface 240 may include additional fields or information in other examples consistent with this

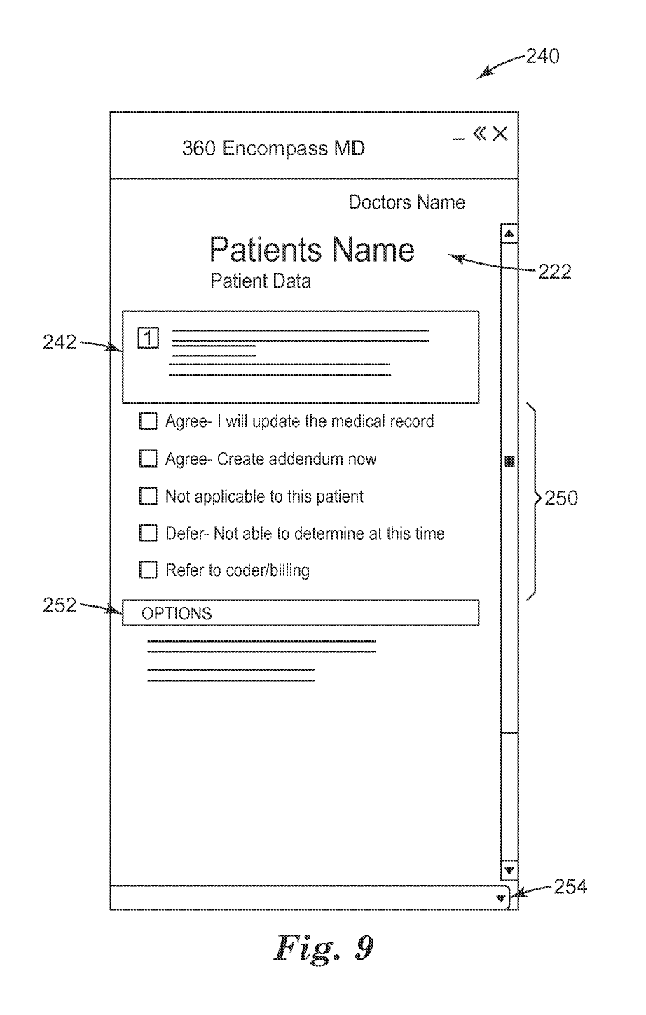

FIG. 9 is an illustration of an example user interface 240 that includes a query with a list of selectable items to resolve the discrepancy. User interface 240 of FIG. 9 is similar to user interface 240 of FIG. 8, but user interface 240 of FIG. 9 illustrates the changes that occur responsive to user input that selects query 242. As shown in FIG. 9, user interface 240 may include patient information 222, query 242, and options 252. In response to user input selecting query 242 from query field 224 in FIG. 8, user interface 240 may expand query 242 to show a list of one or more selectable items 250. User interface 240 may receive user input from a physician selecting one or more of selectable items 250 to resolve the discrepancy identified by query 242.

Each of selectable items 250 in the list may provide a different manner in which to resolve the discrepancy. Selectable items 250 may include selections such as “Agree—I will update the medical record” and “Agree—Create addendum now” to facilitate immediate resolution of the discrepancy by the physician. Selection of these items may lead to modification of clinical documentation or previously selected code. Selectable items 250 may also include items such as “Not applicable to this patient,” “Defer—not able to determine at this time,” and “Refer to coder/billing” to confirm that the discrepancy is acceptable or push off the resolution of the discrepancy to a later time.

Selection of one of selectable items 250 may cause server 22 to bring the user to another screen in which user input can be provided to modify clinical documentation, add an addendum, or adjust an already selected code. Alternatively, one or more of selectable items 250 may include a suggested code or other suggested adjustment that, when selected, causes server 22 to make a corresponding adjustment to either clinical documentation or a previously selected code. In this manner, query 242 may provide one or more selectable items 250 that, when selected, resolve one or more discrepancies without the physician needing to go back and address the items via a different user interface and/or screen. In some examples, query 242 may include another item to resolve the discrepancy, such as a text box in which the physician may enter information to resolve the discrepancy.

User interface 240 may also include options field 252. Options field 252 may include additional selectable features that allow the physician to view or address other items. For example, options field 252 may include a “Show additional patient information” option or a “Preview response document.” Other options may also be provided such as requests to view clinical documentation, review selected codes, or view any other information related to the patient or coding rules.

The techniques of this disclosure may be implemented in a wide variety of computer devices, such as one or more servers, laptop computers, desktop computers, notebook computers, tablet computers, hand-held computers, smart phones, or any combination thereof. Any components, modules or units have been described to emphasize functional aspects and do not necessarily require realization by one or more different hardware units.

The disclosure contemplates computer-readable storage media comprising instructions to cause a processor to perform any of the functions and techniques described herein. The computer-readable storage media may take the example form of any volatile, non-volatile, magnetic, optical, or electrical media, such as a RAM, ROM, NVRAM, EEPROM, or flash memory that is tangible. The computer-readable storage media may be referred to as non-transitory. A server, client computing device, or any other computing device may also contain a more portable removable memory type to enable easy data transfer or offline data analysis.

The techniques described in this disclosure, including those attributed to server 22, repository 24, and/or computing device 100, and various constituent components, may be implemented, at least in part, in hardware, software, firmware or any combination thereof. For example, various aspects of the techniques may be implemented within one or more processors, including one or more microprocessors, DSPs, ASICs, FPGAs, or any other equivalent integrated or discrete logic circuitry, as well as any combinations of such components, remote servers, remote client devices, or other devices. The term “processor” or “processing circuitry” may generally refer to any of the foregoing logic circuitry, alone or in combination with other logic circuitry, or any other equivalent circuitry.

Such hardware, software, firmware may be implemented within the same device or within separate devices to support the various operations and functions described in this disclosure. For example, any of the techniques or processes described herein may be performed within one device or at least partially distributed amongst two or more devices, such as between server 22 and/or client computing device 12. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Example computer-readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or any other computer readable storage devices or tangible computer readable media. The computer-readable storage medium may also be referred to as storage devices.

In some examples, a computer-readable storage medium comprises non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described herein. Any combination of the described operations or functions is contemplated. These and other examples are within the scope of the following claims.

What is claimed is:

1. A computer-implemented method for managing medical information, the method comprising:
receiving, by a computing device, clinical documentation related to a patient encounter;
receiving, by the computing device, one or more selected codes associated with the patient encounter;
determining, by the computing device, one or more suggested codes associated with the patient encounter and based on clinical documentation;
determining, by the computing device, one or more discrepancies between the one or more selected codes and the one or more suggested codes;
responsive to determining the one or more discrepancies, generating, by the computing device and based on the one or more discrepancies, a query that indicates the one or more discrepancies and solicits user input resolving the one or more discrepancies; and
outputting the query for display.

2. The method of claim 1, wherein the query indicates clinical documentation and the one or more selected codes for which the discrepancy was determined.

3. The method of claim 1, wherein the query comprises a list of selectable items, wherein user input selecting one of the selectable items from the list resolves the discrepancy.

4. The method of claim 3, further comprising:
receiving an indication of the user input selecting one of the selectable items from the list; and
modifying, based on the indication of the user input, at least one of clinical documentation and the one or more selected codes to resolve the discrepancy.

5. The method of claim 1, wherein determining the one or more suggested codes comprises:
analyzing, by a natural language processing module, clinical documentation for one or more medical concepts; and
generating the one or more suggested codes from the one or more medical concepts.

6. The method of claim 1, further comprising:
responsive to determining the one or more discrepancies, withholding clinical documentation and the one or more selected codes from submission to a billing system;
receiving user input updating at least one of clinical documentation and the one or more selected codes to resolve the discrepancy; and
responsive to receiving the user input, submitting at least one of the updated clinical documentation or the updated one or more selected codes to the billing system.

7. The method of claim 1, wherein clinical documentation comprises a natural language representation of the patient encounter created by the physician.

8. The method of claim 1, wherein the one or more selected codes comprises at least one of an evaluation and management code, a diagnosis code, a procedural code, and a prescribed medication.

9. The method of claim 1, wherein billing information for the patient encounter is generated from the one or more selected codes.

10. A computerized system for managing medical information, the system comprising:
one or more computing devices configured to:
receive clinical documentation related to a patient encounter;
receive one or more selected codes associated with the patient encounter;
determine one or more suggested codes from associated with the patient encounter and based on clinical documentation;
determine one or more discrepancies between the one or more selected codes and the one or more suggested codes;
responsive to determining the one or more discrepancies, generate, based on the one or more discrepancies, a query that indicates the one or more discrepancies and solicits user input resolving the one or more discrepancies; and
output the query for display.

11. The system of claim 10, wherein the query indicates clinical documentation and the one or more selected codes for which the discrepancy was determined.

12. The system of claim 10, wherein the query comprises a list of selectable items, wherein user input selecting one of the selectable items from the list resolves the discrepancy.

13. The system of claim 12, wherein the computing device is configured to:
receive an indication of the user input selecting one of the selectable items from the list; and
modify, based on the indication of the user input, at least one of clinical documentation and the one or more selected codes to resolve the discrepancy.

14. The system of claim 10, further comprising:
a natural language processing module configured to analyze clinical documentation for one or more medical concepts; and
a discrepancy module configured to generate the one or more suggested codes from the one or more medical concepts.

15. The system of claim 10, wherein the one or more computing devices are configured to:
responsive to determining the one or more discrepancies, withhold clinical documentation and the one or more selected codes from submission to a billing system;
receive user input updating at least one of clinical documentation and the one or more selected codes to resolve the discrepancy; and
responsive to receiving the user input, submit at least one of the updated clinical documentation or the updated one or more selected codes to the billing system.

16. The system of claim 10, wherein clinical documentation comprises a natural language representation of the patient encounter created by the physician.

17. The system of claim 10, wherein the one or more selected codes comprises at least one of an evaluation and management code, a diagnosis code, a procedural code, and a prescribed medication.

18. The system of claim 10, wherein billing information for the patient encounter is generated from the one or more selected codes.

19. A computer-readable storage medium comprising instructions that, when executed, cause one or more processors to:
receive clinical documentation related to a patient encounter;
receive one or more selected codes associated with the patient encounter;
determine one or more suggested codes associated with the patient encounter and based on clinical documentation;
determine one or more discrepancies between the one or more selected codes and the one or more suggested codes;
responsive to determining the one or more discrepancies, generate, based on the one or more discrepancies, a query that indicates the one or more discrepancies and solicits user input resolving the one or more discrepancies; and
output the query for display.

20. The computer-readable storage medium of claim 19, further comprising instructions that, when executed, cause one or more processors to:
responsive to determining the one or more discrepancies, withhold clinical documentation and the one or more selected codes from submission to a billing system;
receive user input updating at least one of clinical documentation and the one or more selected codes to resolve the discrepancy; and
responsive to receiving the user input, submit at least one of the updated clinical documentation or the updated one or more selected codes to the billing system.
